(19) United States
(12) Patent Application Publication
(10) Pub. No.: US 2015/0095389 A1
(43) Pub. Date: Apr. 2, 2015

(54) METHOD AND SYSTEM FOR GENERATING PSEUDORANDOM NUMBERS IN PARALLEL

(71) Applicant: Oracle International Corporation, Redwood City, CA (US)

(72) Inventor: Guy L. Steele, Lexington, MA (US)

(73) Assignee: Oracle International Corporation, Redwood City, CA (US)

(21) Appl. No.: 14/043,372

(22) Filed: Oct. 1, 2013

(51) Int. Cl. G06F 7/58; G06F 9/46

(52) U.S. Cl. CPC G06F 7/582; G06F 9/46
USPC 708/250

(57) ABSTRACT

The disclosed embodiments relate to a system that generates a pseudorandom number. During operation, the system maintains a current dot-product for a thread, wherein the current dot-product is a dot-product between a pedigree for the thread and an array of coefficients, wherein the pedigree for the thread comprises an array of elements that specify a path to the thread from a root in a dynamic multi-threading hierarchy, and wherein the array of coefficients includes a coefficient for each level in the dynamic multi-threaded hierarchy. To generate the pseudorandom number, the system incrementally computes a new dot-product from the current dot-product without performing a multiplication operation by adding a coefficient associated with the thread's level in the dynamic multi-threading hierarchy to the current dot-product. Next, the system performs a mixing operation on the new dot-product to produce the pseudorandom number. Finally, the system updates the current dot-product to the new dot-product.

### BACKGROUND

1. Field

The disclosed embodiments generally relate to techniques for generating pseudorandom numbers in computer systems. More specifically, the disclosed embodiments relate to techniques for efficiently generating pseudorandom numbers in parallel in a dynamic multi-threaded hierarchy.

2. Related Art

Many applications rely on a source of pseudorandom numbers or bit strings that appear or behave as if generated by a truly random source. One class of applications that may use pseudorandom numbers is the so-called “Monte Carlo methods.” Another class makes use of Markov chains. The quality of a source of pseudorandom numbers may be judged by applying any of a variety of statistical tests to its output. One widely used test is the Dieharder software suite. (See “Dieharder: A Random Number Test Suite,” Robert G. Brown, et al., Version 3.31.1. http://www.phy.duke.edu/˜rgb/General/dieharder.php.)

There is a large literature on sequential algorithms for generating pseudorandom number sequences. One that is widely considered to be of very high quality is the Mersenne twister (See “Mersenne Twister: A 623-Dimensionally Equidistributed Uniform Pseudo-Random Number Generator,” by Matsumoto, M. and Nishimura, T., ACM Transactions on Modeling and Computer Simulation 8 (1): 3-30. doi:10.1145/272991.272995 (1998)).

It is also possible to generate “genuinely” random numbers by using the results of a physical process that is believed to have random behavior.

There is also a close relationship between generating pseudorandom numbers and the generating of hash values for data structures. In particular, a stream of pseudorandom numbers can in principle be generated by applying an appropriate hashing function to a stream of successive integers. Some hash functions are constructed by first reducing a large data structure to an integer of fixed size and then applying a “finalizer,” which may be a “mixing function” that “mixes” the values of the individual bits used to represent the integer. One example of this approach is the MurmurHash3 technique developed by Austin Appleby, which uses a 64-bit finalizer when generating a 64-bit hash. (See http://code.google.com/p/smhasher/wiki/MurmurHash3, which is referred to as the “Appleby paper.”) Variations of this 64-bit finalizer function are discussed in a paper by David Stafford, entitled “Better Bit Mixing—Improving on MurmurHash3's 64-bit Finalizer,” http://zimbry.blogspotcom/2011/09/better-bit-mixing-improving-on.html (referred to as “the Stafford paper”). Each of these finalizer functions takes a 64-bit input and produces a 64-bit result. Each of these functions is bijective: distinct inputs produce distinct results. Each of these functions also has good “avalanche statistics,” meaning that, on average over all possible inputs, changing just one bit of the input has, for each of the 64 output bits, roughly a 50% chance of changing that output bit.

A more difficult problem than generating a sequence of pseudorandom numbers by a sequential method is to provide a deterministic technique that can be used by multiple shared threads of control (also referred to as “tasks”) that execute in parallel, in such a manner that each thread can independently generate a sequence of pseudorandom numbers, and yet the single set of numbers generated by all the threads collectively still has good statistical properties. It is desirable to employ such a deterministic technique when using parallel processing hardware such as CPU clusters to carry out the computations for an application such as a Monte Carlo simulation. It is also desirable to have such a deterministic technique when using vector processing hardware or SIMD hardware, such as one or more graphic processing units (GPUs), to carry out computations of that class.

Leiserson, Schardl, and Sukha describe a technique they call DOTMIX, which allows computational tasks running in parallel to generate pseudorandom sequences independently. (See “Deterministic Parallel Random-Number Generation for Dynamic-Multithreading Platforms,” Charles E. Leiserson, Tao B. Schardl, and Jim Sukha, Proceedings of the 17th ACM SIGPLAN Symposium on Principles and Practice of Parallel Programming (PPoPP '12) ACM, New York, N.Y., USA, 193-204, 2012, referred to as the “Leiserson paper”.) In their model, a computation initially comprises a single task, and any task may at any time spawn a new task, synchronize with tasks it has spawned (waiting for them to complete), or generate a pseudorandom number. The basic idea is that each such action (spawn, sync, or generate) is associated with a unique “pedigree,” which is an ordered vector of integers. Computations occur at each spawn, sync, or generate operation to ensure that every action, within the set of all actions performed by all tasks, will have a distinct pedigree. Additionally, the generate operation produces a pseudorandom number by performing a two-part mathematical computation on the pedigree of the generate operation: a dot-product with a vector of coefficients, followed by a “mixing” operation that conceptually “scrambles” the result of the dot-product. The name “DOTMIX” comes from this two part-process of a DOT-product followed by a MIX-function. The vector of coefficients is drawn from a fixed table of coefficients that is defined, ideally by some truly random process, before execution of the initial task begins.

One drawback of the DOTMIX technique is that the cost of computing the dot-product is proportional to the length of the pedigree; if tasks are deeply nested, pedigrees can become quite long. While the Leiserson paper mentions that they tried using a “memoizing” technique to avoid this drawback, it also reports that using this memoizing technique failed to improve overall performance.

Another drawback of the DOTMIX technique is that it requires the dot-product to be computed modulo a large prime (2⁶⁴−59), that is, the integer that is 59 less than the value two to the sixty-fourth power. This requirement makes the multiplication operations needed to compute the dot-product particularly expensive.

A further drawback of the DOTMIX technique is that it generates 64-bit pseudorandom integers but does not generate all 2⁶⁴ possible values; there are certain 64-bit numbers (59 of them) that will never be generated.

Yet another drawback of the DOTMIX technique is that the maintenance of pedigree information is tied to task spawning and synchronization operations and to the data structures used to represent tasks and their relationships. One consequence of this fact is that parts of an application not making use of pseudorandom numbers must nevertheless pay the overhead of pedigree maintenance at every task spawn and task sync action.

Hence, what is needed is a technique for computing pseudorandom numbers in parallel without the above-listed drawbacks of existing techniques.

### SUMMARY

The disclosed embodiments relate to a system that generates a pseudorandom number. During operation, the system maintains a current dot-product for a thread, wherein the current dot-product is a dot-product between a pedigree for the thread and an array of coefficients, wherein the pedigree for the thread comprises an array of elements that specify a path to the thread from a root in a dynamic multi-threading hierarchy, and wherein the array of coefficients includes a coefficient for each level in the dynamic multi-threaded hierarchy. To generate the pseudorandom number, the system incrementally computes a new dot-product from the current dot-product without performing a multiplication operation by adding a coefficient associated with the thread's level in the dynamic multi-threading hierarchy to the current dot-product. Next, the system performs a mixing operation on the new dot-product to produce the pseudorandom number. Finally, the system updates the current dot-product to the new dot-product.

In some embodiments, after spawning a child thread for the thread, the system enables the child thread to generate pseudorandom numbers by performing the following operations. First, the system incrementally computes a new dot-product from the current dot-product for the thread by adding a coefficient associated with the thread's level in the dynamic multi-threading hierarchy to the current dot-product. Next, the system uses the new dot-product as a current dot-product for the child thread during a subsequent pseudorandom number computation involving the child thread. The system also updates the current dot-product to the new dot-product.

In some embodiments, using the new dot-product as the current dot-product for the child thread involves communicating the new dot-product to the child thread outside of thread state information and outside of a system stack.

In some embodiments, performing the mixing operation includes using a MurmurHash3 64-bit finalizer function to perform the mixing operation.

In some embodiments, performing the mixing operation includes using a mix32 function to perform the mixing operation, wherein the mix32 function performs a subset of the operations in a MurmurHash3 64-bit finalizer function and produces a 32-bit result.

In some embodiments, adding the coefficient to compute the new dot-product includes performing an addition operation modulo a prime number that is larger than can be represented in an integer type being used for the addition operation.

In some embodiments, if performing the additional operation modulo the prime number produces a resulting value that is larger than can be represented in the integer type, the system performs a second addition operation modulo the prime number between the resulting value and the coefficient.

In some embodiments, the coefficients in the array of coefficients are selected to ensure that the second addition operation modulo the prime number results in a value that can be represented in the integer type.

### BRIEF DESCRIPTION OF THE FIGURES

FIG. 1 illustrates a tree of task actions in accordance with the disclosed embodiments.

FIG. 2 illustrates the tree of task actions including data structures associated with tasks in accordance with the disclosed embodiments.

FIG. 3 illustrates a table of random numbers in accordance with the disclosed embodiments.

FIG. 4 presents code that enables multiple tasks to execute in parallel to compute pseudorandom numbers in a manner consistent with the DOTMIX technique in accordance with the disclosed embodiments.

FIG. 5 illustrates the tree of task actions including specific data structures that facilitate efficiently generating pseudorandom numbers in accordance with the disclosed embodiments.

FIG. 6 presents code that enables multiple tasks to execute in parallel to compute pseudorandom numbers in accordance with the disclosed embodiments.

FIG. 7 illustrates code that defines a class called “IncrementalRandom” in accordance with the disclosed embodiments.

FIG. 8 illustrates code that defines a field and methods for the class IncrementalRandom in accordance with the disclosed embodiments.

FIG. 9 illustrates code that can be used to generate a pseudorandom value in accordance with the disclosed embodiments.

FIG. 10 illustrates code that can be used to fill in an array with pseudorandom values in accordance with the disclosed embodiments.

FIG. 11 illustrates code that can be used to fill in an array with pseudorandom values in accordance with the disclosed embodiments.

FIG. 12 illustrates code that can be used to fill in an array with pseudorandom long values in accordance with the disclosed embodiments.

FIG. 13 presents a flow chart illustrating the process of generating a pseudorandom number in accordance with the disclosed embodiments.

FIG. 14 presents a flow chart illustrating the process of enabling a child process to generate pseudorandom numbers in accordance with the disclosed embodiments.

FIG. 15 illustrates a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the present invention will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

### Technique for Generating Pseudorandom Numbers in Parallel

The disclosed embodiments address the drawbacks of the above-referenced DOTMIX technique for generating pseudorandom numbers. When generating pseudorandom numbers according to the disclosed embodiments, the cost of generating one pseudorandom number is bounded by a constant and is independent of the length of a pedigree; no multiplication operations are used to compute the dot-product; all possible 64-bit values may be generated, with uniform probability; and, in one embodiment, pedigree information is maintained in a data structure that is independent of the representation of tasks, thereby decoupling the overhead of pedigree maintenance from the actions of task spawn and task sync operations. Finally, the disclosed embodiments provide a method for even more efficient bulk generation of many pseudorandom numbers at once as a single action; this method is particularly suitable for execution on modern GPU hardware.

In the disclosed embodiments, a computation is considered to be organized as a tree of tasks that perform actions, which themselves may be regarded as forming a tree. Each task executes some sequential computation that performs one action after another, and all tasks collectively execute their sequential computations in parallel. Initially, one task is started, and during the course of execution, any task may perform the action of spawning a new task; this new task is considered to be a “child” task of the task that spawned it, and the task that performed the spawn action is considered to be a “parent” of the spawned task. As soon as a task is spawned, it proceeds to execute its own sequential computation in parallel with, and more or less independently of, all other tasks. (We say “more or less” because it may be possible for tasks to synchronize with one another or to communicate with one another by some means not specified here.) Each task may also, during the course of its sequential computation, perform the action of generating a pseudorandom number. Each task may spawn any number of child tasks and may generate any number of pseudorandom numbers, and these two kinds of action may be interleaved in any order.

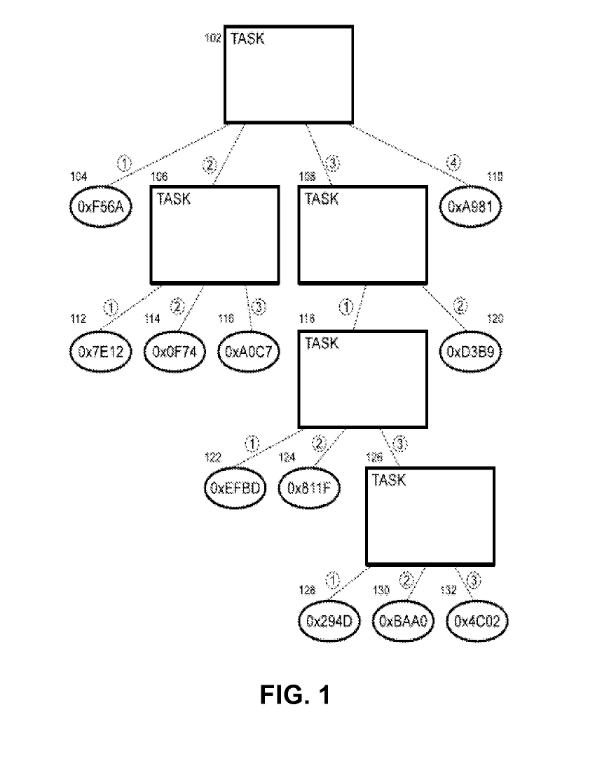

FIG. 1 shows an illustrative tree of task actions. The tree has at its root a first task 102, which is the initial task of the computation. Over the course of the computation, the first task 102 performs four actions: its first action is to generate a first pseudorandom number 104 (for illustrative purposes, the generated value 0xF56A is shown); its second action is to spawn a second task 106; its third action is to spawn a third task 108; and its fourth action is to generate a second pseudorandom number 110 (for illustrative purposes, the value 0xA981 is shown). It will be appreciated that the second task 106 is a child task of the first task 102, and that, therefore, the first task 102 is the parent of the second task 106.

Similarly, it will be appreciated that the third task 108 is a child task of the first task 102, and that, therefore, the first task 102 is the parent of the third task 108.

Over the course of the computation, the second task 106 performs three actions: its first action is to generate a third pseudorandom number 112 (for illustrative purposes, the generated value 0x7E12 is shown); its second action is to generate a fourth pseudorandom number 114 (for illustrative purposes, the generated value 0x0F74 is shown); and its third action is to generate a fifth pseudorandom number 116 (for illustrative purposes, the value 0xA0C7 is shown).

Over the course of the computation, the third task 108 performs two actions: its first action is to spawn a fourth task 118; and its second action is to generate a sixth pseudorandom number 120 (for illustrative purposes, the value 0xD3B9 is shown).

Over the course of the computation, the fourth task 118 performs three actions: its first action is to generate a seventh pseudorandom number 122 (for illustrative purposes, the generated value 0xEFBD is shown); its second action is to generate an eighth pseudorandom number 124 (for illustrative purposes, the generated value 0x811F is shown); and its third action is to spawn a fifth task 126.

Over the course of the computation, the fifth task 126 performs three actions: its first action is to generate a ninth pseudorandom number 128 (for illustrative purposes, the generated value 0x294D is shown); its second action is to generate a tenth pseudorandom number 130 (for illustrative purposes, the generated value 0xBAA0 is shown); and its third action is to generate an eleventh pseudorandom number 132 (for illustrative purposes, the value 0x4C02 is shown).

It will be appreciated that in FIG. 1, every generated pseudorandom number is connected by a dashed line drawn upward to the task that generates it, and every spawned task is connected by a dashed line drawn upward to the task that spawns it. It will also be appreciated that every such dashed line is labeled with a number presented within a dashed circle, where the number indicates the ordinal position of the action, within the sequence of actions performed by the task at the upper end of the dashed line, that generated the pseudorandom number, or spawned the task, at the lower end of the dashed line. For example, because the third task 108 is spawned by the third action sequentially performed by the first task 102, there is a dashed line in FIG. 1 connecting the first task 102 to the third task 108, and this dashed line is labeled by the number 3 presented within a dashed circle.

It will be appreciated that, because the first task 102 executes its actions in sequential order and the second task 106 does not execute any actions until it has been spawned, the first pseudorandom number 104 is necessarily generated before the third pseudorandom number 112. It will also be appreciated that, because the second task 106 may execute in parallel with later actions of the first task 102, the third pseudorandom number 112 may be generated before, during, or after the generation of the second pseudorandom number 110. It will also be appreciated that, because the second task 106 executes its actions in sequential order, the third pseudorandom number 112 is necessarily generated before the fourth pseudorandom number 114. Similar remarks apply to the timing relationships between other pairs of generated pseudorandom numbers shown in FIG. 1.

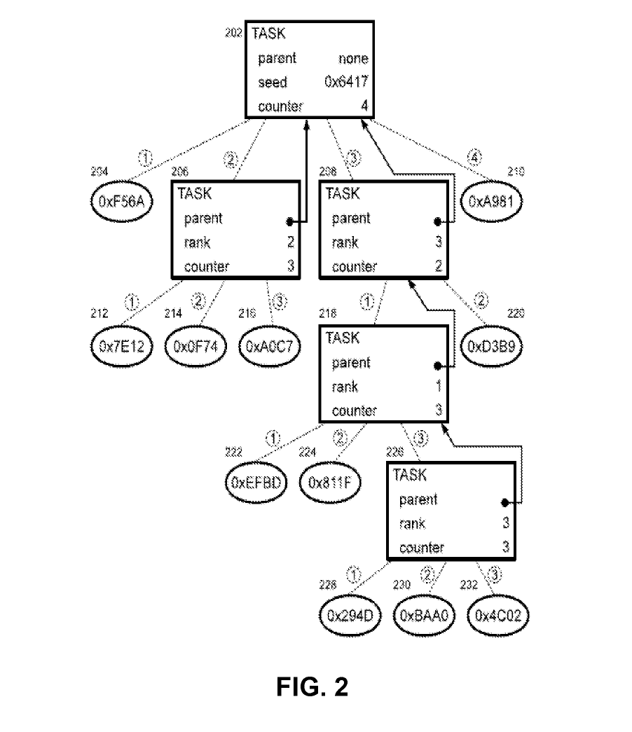

FIG. 2 shows the same illustrative tree of task actions as FIG. 1, but also shows a specific representation of data structures associated with the tasks that allow a specific algorithm to compute the pseudorandom numbers illustrated in a manner quite similar (though not identical) to the algorithm described by Leiserson, Schardl, and Sukha. It will be appreciated that corresponding parts of FIG. 1 and FIG. 2 have similar numbers; for example, the second task 206 of FIG. 2 corresponds to the second task 106 of FIG. 1. In FIG. 2, each task is considered to be a data structure containing at least three fields. The first task 202 shown in FIG. 2 has a first field called the “parent” field, a second field called the “seed” field, and a third field called the “counter” field. In general, the initial task of a computation always has a “parent” field holding the value “none” to indicate that it does not refer to another task, a “seed” field containing an integer value having the same representation as the pseudorandom numbers to be generated, and a “counter” field of sufficient size to count the number of actions that will ever be executed by the task. The second task 206 shown in FIG. 2 has a first field called the “parent” field, a second field called the “rank” field, and a third field called the “counter” field. In general, any task spawned during the computation always has an associated “parent” field that refers to the data structure corresponding to the task that spawned this task, a “rank” field containing an integer value that is the same as the number that labels the dashed line from the task to its parent (that is, the position within the sequence of actions performed by the parent task of the action that spawned this task), and a “counter” field of sufficient size to count the number of actions that will ever be executed by the task. Leiserson, Schardl, and Sukha suggest that the “seed,” “rank,” and “counter” fields each be represented as 64-bit binary integers. It will be appreciated that in one implementation of this data structure, a single field might be provided in every task data structure that serves as a “seed” field if the associated “parent” field contains the value “none” but serves as a “rank” field if the associated “parent” field does not contain the value “none.”

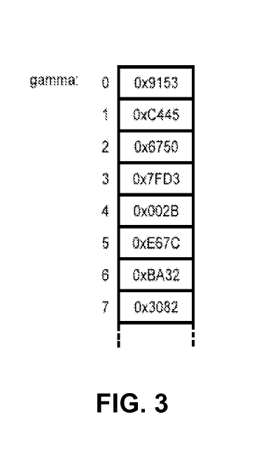

FIG. 3 shows an illustrative table of random numbers, consistent with the algorithm described by Leiserson, Schardl, and Sukha, chosen before initiation of the computation for use by the algorithm that generated the pseudorandom numbers. This table is a linear array that may be indexed by a non-negative integer, and each entry is an integer value having the same representation as the pseudorandom numbers to be generated. Leiserson, Schardl, and Sukha suggest that these table entries each be represented as 64-bit binary integers, and refer to the entries of this table as “gamma” values.

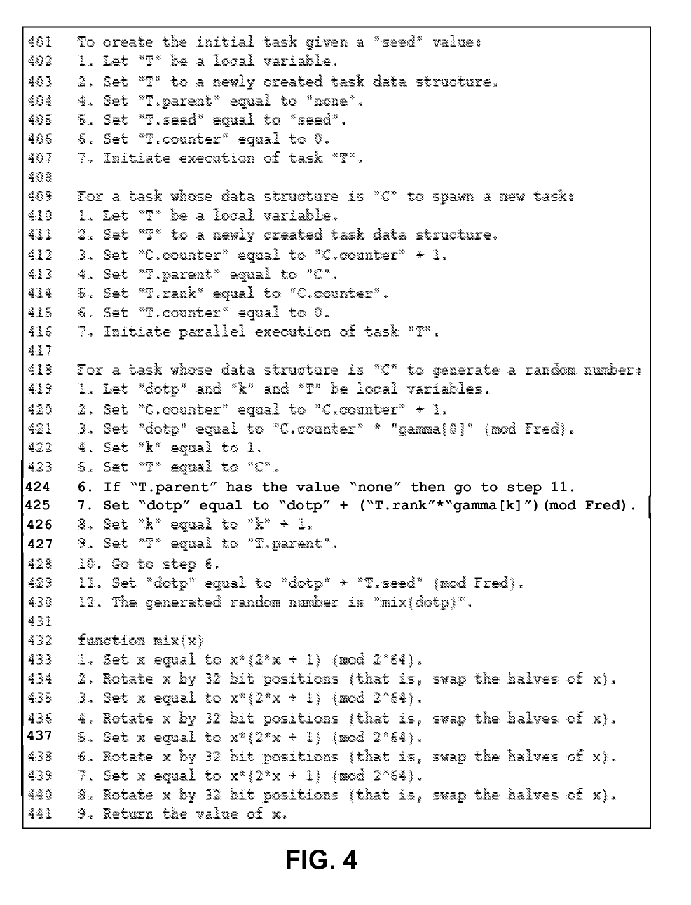

FIG. 4 shows four programmed methods that together constitute a method that enables multiple tasks executing in parallel to compute pseudorandom numbers in a manner consistent with the algorithm described by Leiserson, Schardl, and Sukha.

Lines 401 through 407 constitute a programmed method to be performed when the initial task is to be created. Line 401 specifies that an initial integer “seed” value is to be chosen and provided. (It is implicitly assumed that a “gamma” array as shown in FIG. 3 has also been chosen and provided.) Line 402 provides for a local variable named “T.” Line 403 allocates a new data structure for the initial task and causes “T” to refer to this new data structure. Line 404 initializes the “parent” field of the new data structure to “none.” Line 405 initializes the “seed” field of the new data structure to the provided “seed” value. Line 406 initializes the “counter” field of the new data structure to 0. Line 407 initiates execution of the initial task.

Lines 409 through 416 constitute a programmed method to be performed when a task is to perform the action of spawning a new task. Line 409 specifies that the data structure associated with the task performing the action is to be known by the name “C.” Line 410 provides for a local variable named “T.” Line 411 allocates a new data structure for the task to be spawned and causes “T” to refer to this new data structure. Line 412 adds 1 to the “counter” field of “C.” Line 413 initializes the “parent” field of the new data structure to refer to the data structure “C.” Line 414 initializes the “rank” field of the new data structure to the value in the “counter” field of “C.” Line 415 initializes the “counter” field of the new data structure to 0. Line 416 initiates parallel execution of the spawned task.

Lines 418 through 430 constitute a programmed method to be performed when a task is to perform the action of generating a pseudorandom number. Line 418 specifies that the data structure associated with the task performing the action is to be known by the name “C.” Line 419 provides for local variables named “dotp” and “k” and “T.” Line 420 adds 1 to the “counter” field of “C.” Line 421 gives “dotp” a value computed by multiplying the “counter” field of “C” by entry 0 of the gamma table, performing the multiplication modulo a fixed value named “Fred,” which must be a prime number; Leiserson, Schardl, and Sukha suggest that this value be (2⁶⁴−59), that is, the integer that is 59 less than the value two to the sixty-fourth power. Line 422 sets “k” equal to 1. Line 423 sets “T” equal to “C.” It will be appreciated that lines 424 through 428 constitute a loop that follows the chain of “parent” field reference from the current task to the initial task. Line 424 tests whether the “parent” field of “T” contains the value “none;” if so, the loop is terminated by branching to step 11 on line 429. Line 425 updates the value in “dotp” by adding to it the result of multiplying the “rank” field of T by entry “k” of the gamma table, all arithmetic being performed modulo the value “Fred.”

Line 426 adds 1 to “k.” Line 427 updates “T” to refer to the data structure for the parent task of the task associated with “T.” Line 428 transfers control to step 6 on line 424 for continued iteration of the loop. On termination of the loop on lines 424 through 428, line 429 adds the value in the “seed” field of “T” to “dotp,” performing the addition operation modulo the value “Fred.” Line 430 produces the pseudorandom number by calling a mixing function “mix,” giving it the value in “dotp” as an argument. It will be appreciated that the steps on lines 421 through 428 compute a dot-product of a vector of counter and rank values with a vector of values taken from the gamma table, and that line 429 then adds a seed value to this dot-product before it is given to the mixing function “mix,” all in accordance with the algorithm described by Leiserson, Schardl, and Sukha.

Lines 432 through 441 implement the mixing function recommended by Leiserson, Schardl, and Sukha; it consists of four iterations of two steps each. The first step in each of the four iterations (lines 433, 435, 437, and 439) is to replace the value “x” with the result of computing the polynomial 2x²+x modulo 2⁶⁴ (two to the sixty-fourth power). The second step in each of the four iterations (lines 434, 436, 438, and 440) is to replace the value “x” with the result of rotating the bits of “x” 32 positions (that is, swapping the halves of the binary representation of “x”). Line 441 returns the fully transformed value of “x” as the result of the mixing function.

Referring back to FIG. 2, for illustrative purposes we chose the mixing function “mix” to be the identity function that simply returns its argument, rather than the “mix” function shown on lines 432 through 441, and chose Fred to be the prime number 65521 (expressed in decimal notation). It will be appreciated that when the first pseudorandom number 204 is to be computed by the first task 202, using the programmed method shown on lines 418 through 430, the “counter” field for the first task 202 has the value 0, and the “seed” field for the first task 202 has the value 0x6417. The programmed procedure on lines 418 through 430 increments this value from 0 to 1; this value 1 is then multiplied by “gamma[0]” which (referring to FIG. 3) is the value 0x9153 (expressed in hexadecimal notation). The value of the dot-product is therefore 0x9153. This value is then added to the “seed” value 0x6417, modulo Fred, to produce the value 0xF56A. The mixing function then returns this same value, which is shown in FIG. 2 as the illustrative value for the first pseudorandom number 204.

It will also be appreciated that when the tenth pseudorandom number 230 is to be computed by the fifth task 226, using the programmed method shown on lines 418 through 430, the “counter” field for the fifth task 226 has the value 1, the “rank” field for the fifth task has the value 3, the “rank” field for the fourth task 218 has the value 1, the “rank” field for the third task 208 has the value 3, and the “seed” field for the first task 202 has the value 0x6417. The programmed procedure on lines 418 through 430 increments the “counter” field for the fifth task 226 from 1 to 2; this value 2 is then multiplied by “gamma[0]” which (referring to FIG. 3) is the value 0x9153 (expressed in hexadecimal notation). The loop on lines 424 through 428 then adds to “dotp” the result of multiplying “gamma[1]” (the value 0xC445) by the value of the “rank” field of the fifth task 226 (the value 3), the result of multiplying “gamma[2]” (the value 0x6750) by the value of the “rank” field of the fourth task 218 (the value 1), and the result of multiplying “gamma[1]” (the value 0x7FD3) by the value of the “rank” field of the third task 208 (the value 3). This value is then added to the “seed” value 0x6417, modulo Fred, to produce the value 0xBAA0. The mixing function then returns this same value 0xBAA0, which is shown in FIG. 2 as the illustrative value for the tenth pseudorandom number 230.

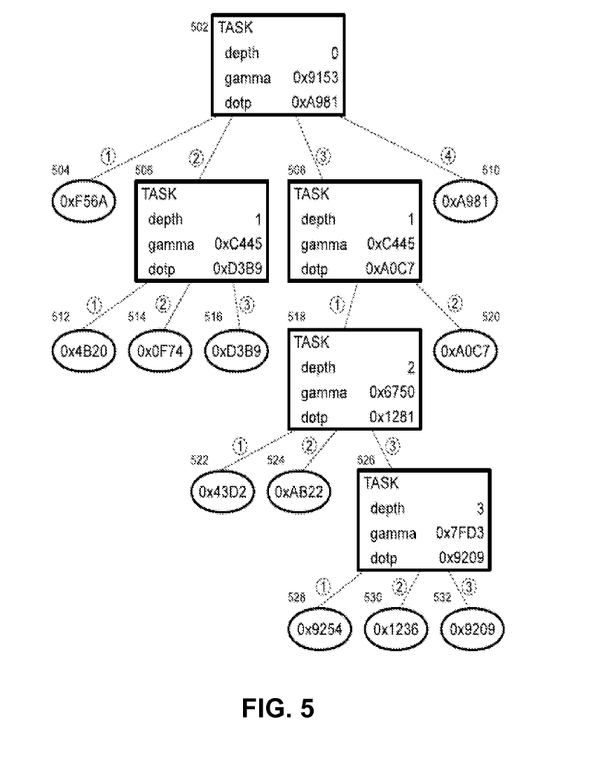

FIG. 5 shows the same illustrative tree of task actions as FIG. 1, but also shows a specific novel representation of data structures associated with the tasks, consistent with the disclosed embodiments, that support a specific method for computing pseudorandom numbers in a manner consistent with the disclosed embodiments. It will be appreciated that corresponding parts of FIGS. 1-2 and FIG. 5 all have similar numbers; for example, the second task 506 of FIG. 5 corresponds to the second task 106 of FIG. 1 and likewise to the second task 206 of FIG. 2. In FIG. 5, each task is considered to be a data structure containing at least three fields. The first task 502 shown in FIG. 5 has a first field called the “depth” field, a second field called the “gamma” field, and a third field called the “dotp” field. In general, every task of a computation always has a “depth” field containing an integer that is the distance of the task from the root of the task tree, a “gamma” field containing a value copied from the gamma table as illustrated in FIG. 3, and a “dotp” field containing an integer value having the same representation as the pseudorandom numbers to be generated. It will be appreciated that these data structures advantageously do not contain references or pointers from one to another; all three fields are integer values.

In the disclosed embodiments, the “depth,” “gamma,” and “dotp” fields of a task data structure are all represented as 64-bit binary integers. In another embodiment, the “depth” field is represented as a 32-bit binary integer and the “gamma” and “dotp” fields are each represented as a 64-bit binary integer. It will be appreciated by one of ordinary skill in the art that other sizes or representations may be used for these fields without departing from the spirit and scope of the disclosed embodiments.

It will be appreciated that although the tree of tasks and the tree of task actions described by FIG. 5 are identical to those shown in FIGS. 1 and 2, the illustrative values shown for the generated pseudorandom numbers are different.

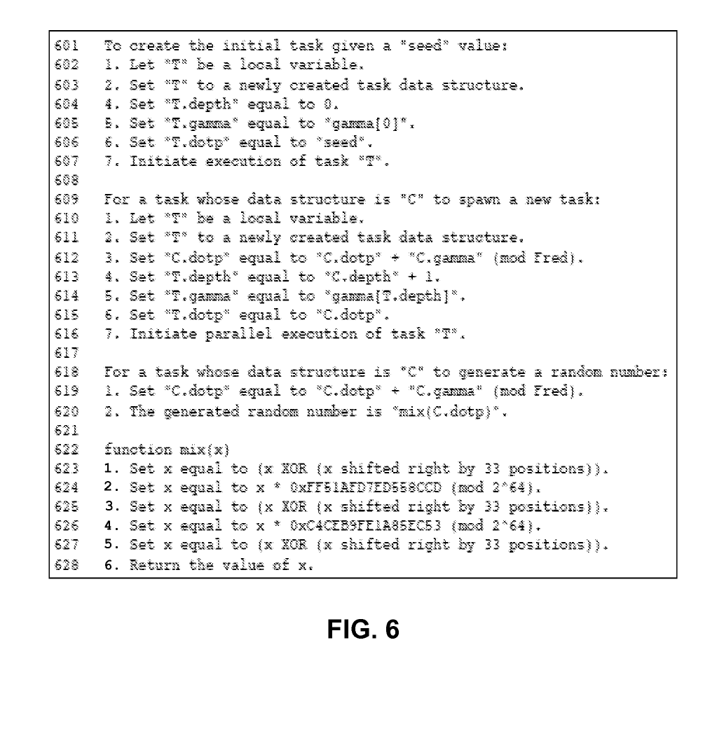

FIG. 6 shows four programmed methods that together constitute a method that enables multiple tasks executing in parallel to compute pseudorandom numbers in a manner consistent with the disclosed embodiments. These four methods correspond in a general way to the four programmed methods shown in FIG. 4, and present similar external interfaces to software that uses them, but their specific details are novel.

Lines 601 through 607 constitute a programmed method to be performed when the initial task is to be created. Line 601 specifies that an initial integer “seed” value is to be chosen and provided. (It is implicitly assumed that a “gamma” array as shown in FIG. 3 has also been chosen and provided.) Line 602 provides for a local variable named “T.” Line 603 allocates a new data structure for the initial task and causes “T” to refer to this new data structure. Line 604 initializes the “depth” field of the new data structure to 0. Line 605 initializes the “gamma” field of the new data structure to entry 0 of the gamma table. Line 606 initializes the “dotp” field of the new data structure to the provided “seed” value. Line 607 initiates execution of the initial task.

Lines 609 through 616 constitute a programmed method to be performed when a task is to perform the action of spawning a new task. Line 609 specifies that the data structure associated with the task performing the action is to be known by the name “C.” Line 610 provides for a local variable named “T.” Line 611 allocates a new data structure for the task to be spawned and causes “T” to refer to this new data structure. Line 612 adds the “gamma” field of “C” into the “dotp” field of “C,” performing the addition modulo a fixed value “Fred,” which must be a prime number. In the disclosed embodiments, the value “Fred” is (2⁶⁴−59), that is, the integer that is 59 less than the value two to the sixty-fourth power. Line 613 initializes the “depth” field of the new data structure to 1 more than the value in the “depth” field of “C.” Line 614 initializes the “gamma” field of the new data structure to an entry in the gamma table determined by the value of the “depth” field of “T.” Line 615 initializes the “dotp” field of the new data structure to the value in the “dotp” field of “C.” Line 616 initiates parallel execution of the spawned task.

Lines 618 through 620 constitute a programmed method to be performed when a task is to perform the action of generating a pseudorandom number. Line 618 specifies that the data structure associated with the task performing the action is to be known by the name “C.” Line 619 adds the “gamma” field of “C” into the “dotp” field of “C,” performing the addition modulo the same fixed value “Fred” that is used in line 612. Line 620 produces the pseudorandom number by calling a mixing function “mix,” giving it the value in the “dotp” field of “C” as an argument.

Lines 622 through 628 implement the 64-bit mixing function used in the MurmurHash3 technique described above; it includes five steps. The first, third, and fifth steps (lines 623, 625, 627) each replace the value “x” with the result of performing a bitwise XOR on “x” and the result of shifting “x” rightward 33 bit positions. The second step (line 624) multiplies “x” by the constant 0xFF51AFD7ED558CCD, performing the arithmetic modulo 2⁶⁴. The fourth step (line 626) multiplies “x” by the constant 0xC4CEB9FE1A85EC53, performing the arithmetic modulo 2⁶⁴. Line 628 returns the fully transformed value of “x” as the result of the mixing function.

It will be appreciated that the programmed method shown on lines 618 through 620 advantageously expends much less computational effort than the programmed method shown on lines 418 through 430 in FIG. 4.

More specifically, it will be appreciated that the programmed method shown on lines 618 through 620 requires only a fixed number of steps that is independent of the structure of the task tree, whereas the programmed method shown on lines 418 through 430 includes a loop on lines 424 through 428 that performs a number of iterations equal to the distance within the task tree between the task at the root of the task tree and the task performing the action of generating a pseudorandom number. It will also be appreciated that the programmed method shown on lines 618 through 620 advantageously performs no multiplication operations modulo the value “Fred,” only addition operations, whereas the programmed method shown on lines 418 through 430 always performs at least one multiplication operation modulo the value “Fred.”

Referring back to FIG. 5, we now remark that for illustrative purposes we chose the mixing function “mix” to be the identity function that simply returns its argument, rather than the “mix” function shown on lines 622 through 628, and chose Fred to be the prime number 65521 (expressed in decimal notation). It will be appreciated that when the first pseudorandom number 504 is to be computed by the first task 502, using the programmed method shown on lines 618 through 620, the “gamma” field for the first task 502 has the value 0x9153, and the “dotp” field for the first task 502 has the value 0xA981. The programmed procedure on lines 618 through 620 updates this “dotp” field by adding the “gamma” field to it, producing the new value 0xF56A. The mixing function then returns this same value, which is shown in FIG. 5 as the illustrative value for the first pseudorandom number 504. It will be appreciated that the value 0xA981 shown in FIG. 5 for the “dotp” field of task 502 is the value contained by that field after the entire computation has completed, including generation of the second pseudorandom number 510.

It will also be appreciated that when the tenth pseudorandom number 530 is to be computed by the fifth task 526, using the programmed method shown on lines 618 through 620, the “gamma” field for the fifth task 526 has the value 0x7FD3, and the “dotp” field for the fifth task has the value 0x9209, which is equal to the value of the dot-product (3, 1, 3, 1)·(0x9153, 0xC445, 0x6750, 0x7FD3) (that is, 3×0x9153+1×0xC445+3×0x6750+1×0x7FD3) added to the original seed value 0x6417, all arithmetic being performed modulo the value “Fred.” After line 619 adds the value 0x7FD3 in the “gamma” field of the fifth task 526 into the “dotp” field of the fifth task 526, performing this addition modulo the value “Fred,” the new value in the “dotp” field of the fifth task 526 is therefore 0x1236, which is equal to the value of the dot-product (3, 1, 3, 2)·(0x9153, 0xC445, 0x6750, 0x7FD3) (that is, 3×0x9153+1×0xC445+3×0x6750+2×0x7FD3) added to the original seed value 0x6417, all arithmetic being performed modulo the value “Fred.” It will be appreciated that this is precisely the result of adding the original seed value to the dot-product of the pedigree for the action that generates the tenth pseudorandom number 530 and a vector of gamma values taken from the gamma table. The mixing function then returns this same value 0x1236, which is shown in FIG. 5 as the illustrative value for the tenth pseudorandom number 530.

It will be appreciated that the illustrative value 0x1236 shown in FIG. 5 for the tenth pseudorandom number 530 is different from the illustrative value 0xBAA0 shown in FIG. 2 for the tenth pseudorandom number 230 because the programmed methods shown in FIG. 6 use different vectors of gamma values (more precisely, the methods in FIG. 6 use values from the gamma table in a different order) than the programmed methods shown in FIG. 4. It will also be appreciated that, despite such differences, the programmed methods shown in FIG. 6 have the same properties as the methods shown in FIG. 4 that are necessary to satisfy the proof given by Leiserson, Schardl, and Sukha that the resulting sequence of pseudorandom numbers will have good statistical properties with high probability (provided that an appropriate mixing function is also used, rather than the identity function).

More generally, it will be appreciated that at all times the “dotp” field of the data structure for a task holds the correct value for the original “seed” value added to the dot-product of the pedigree for the action most recently performed by that task (or, if the task has not yet performed any actions, the pedigree for the action that spawned the task) and an appropriate vector of gamma values. It will also be appreciated that the data structures illustrated in FIG. 5 allow the programmed methods shown in FIG. 6 to compute and maintain these dot-product values by taking advantage of the optimization technique well-known to those of ordinary skill in the art as “strength reduction,” allowing dot-products to be computed incrementally and without performing any explicit multiplication operations.

It will be appreciated that the programmed method shown on lines 622 through 628 for the mixing function advantageously expends less computational effort than the programmed method shown on lines 432 through 441 for the mixing function. More specifically, it will be appreciated that the programmed method shown on lines 622 through 628 requires only eight arithmetic operations (two multiplications, three shifts, and three XOR operations), whereas the programmed method shown on lines 432 through 441, even when optimized to take advantage of special instructions on modern processors, typically requires sixteen arithmetic operations (four multiplications, four shifts, four additions of 1, and four rotations).

In an alternative embodiment, the two multiplication constants appearing in lines 624 and 626 may be replaced by another pair of constants, and the three shift distances appearing in lines 623, 625, and 627 (which all happen to be 33 as shown in FIG. 6) may be replaced by a different triplet of shift distances. For example, constants such as those recommended in the Stafford paper (cited above) may be used without departing from the spirit and scope of the disclosed embodiments.

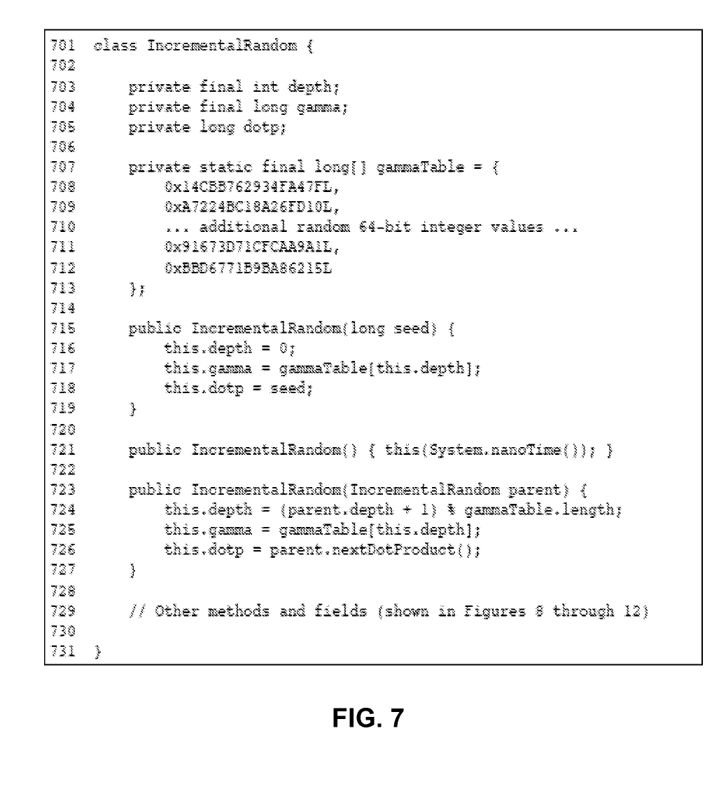

FIGS. 7-12 together show an alternative embodiment, a data structure with associated programmed methods coded in the Java programming language.

FIG. 7 shows the declaration of a data structure, coded as a “class” in the Java programming language, which has the illustrative name “IncrementalRandom” as declared in line 701. Line 703 declares that each instance of this data structure has a 32-bit integer field named “depth” whose value is unchanging once initialized. Line 704 declares that each instance of this data structure has a 64-bit integer field named “gamma” whose value is unchanging once initialized. Line 705 declares that each instance of this data structure has a 64-bit integer field named “dotp” whose value can be updated. Lines 707 through 713 illustrate in relevant part the declaration of an array of 64-bit integer values named “gammaTable;” this single array is “static,” that is, shared by all instances of the data structure. In the disclosed embodiments, the array “gammaTable” has entries whose values (as declared in the code) are determined by using a source of physically random bits, and then verified to lie in the range [13, 2⁶⁴″1], that is, each entry is verified to be not smaller than 13 and also, simply by virtue of being represented in 64 bits, is not larger than 2⁶⁴−1 (two to the sixty-fourth power, minus one). In a further embodiment, the array “gammaTable” has 256 entries. In an alternative embodiment, the array “gammaTable” has 1024 entries.

Lines 715 through 719 declare a constructor method that takes one argument, which is a 64-bit integer value, and initializes a new instance of the “IncrementalRandom” class by using the 64-bit integer value that was received as an argument as the initial seed value, which is stored as the initial value of the “dotp” field of the new instance. Moreover, the “depth” field of the new instance is set to 0; and the “gamma” field of the new instance is set to a copy of an element of the array “gammaTable” that is selected by an index equal to the “depth” field of the new instance (which, in this case, will be the value 0). It will be appreciated that this initialization protocol maintains an invariant that the “gamma” field of any instance of the class “IncrementalRandom” is equal to the element of the array “gammaTable” selected by an index equal in value to the “depth” field of that same instance of the class “IncrementalRandom.”

Line 721 declares a constructor method that takes no arguments and initializes a new instance of the “IncrementalRandom” class by using a time-of-day value, obtained by calling the standard Java library method “System.nanotime,” as an initial seed value.

Lines 723 through 727 declare a constructor method that takes one argument, which is a given, already existing instance of the class “IncrementalRandom,” and initializes a new instance of the “IncrementalRandom” class by using the result of calling the “nextDotProduct” method of the instance of the class “IncrementalRandom” that was received as the argument as the initial seed value, which is stored as the initial value of the “dotp” field of the new instance. Moreover, the “depth” field of the new instance is set to a value that is 1 more than the “depth” field of the instance of the class “IncrementalRandom” that was received as the argument, where the addition of 1 is computed modulo the length of the array “gammaTable;” and the “gamma” field of the new instance is set to a copy of an element of the array “gammaTable” that is selected by an index equal to the “depth” field of the new instance. It will be appreciated that this initialization protocol maintains an invariant that the “gamma” field of any instance of the class “IncrementalRandom” is equal to the element of the array “gammaTable” selected by an index equal in value to the “depth” field of that same instance of the class “IncrementalRandom.” It will furthermore be appreciated that if every entry in “gammaTable” has a value that lies in the range [13, 2⁶⁴−1], then the field “gamma” of every instance of the class “IncrementalRandom” will have a value that lies in the range [13, 2⁶⁴−1].

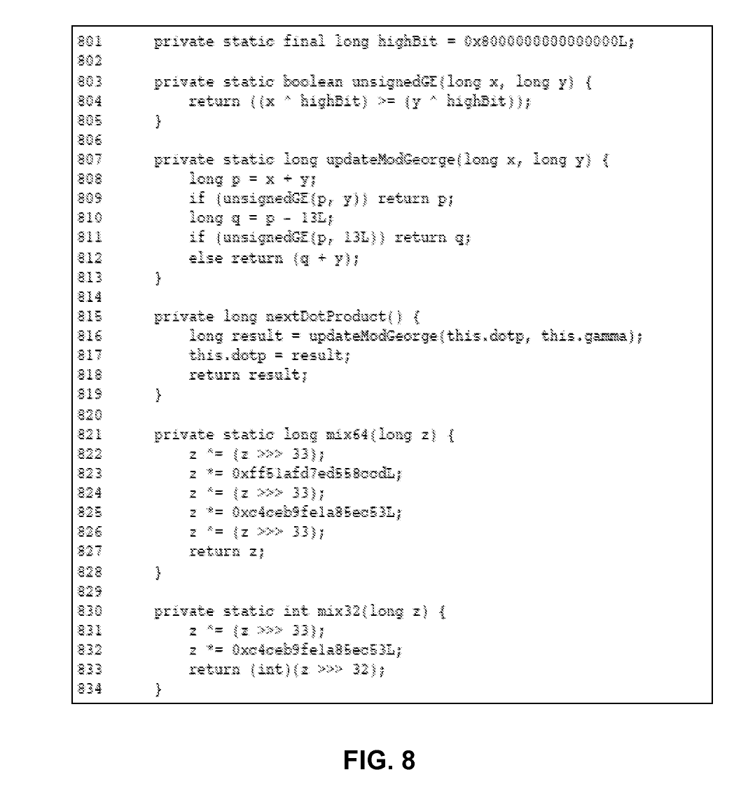

Line 729 has a comment indicating that the class “IncrementalRandom” has other methods and fields, and indeed all of the methods and fields shown in FIGS. 8-12 are to be regarded as if incorporated by reference into FIG. 7 so as to replace line 729.

FIG. 8 shows the declaration of a field and five methods belonging to class “IncrementalRandom.” Line 801 shows a declaration of a field “highBit” that names a 64-bit integer constant whose high-order bit is a 1-bit and whose other 63 bits are 0-bits. Lines 803 through 805 show a method “unsignedGE” that accepts two arguments and returns a Boolean value indicating whether or not the first argument is greater than or equal to the second argument when they are regarded as unsigned 64-bit integers. The algorithm used by method “unsignedGE” will be familiar to one of ordinary skill in the art; it is described, for example, at page 23 of a book by Henry S. Warren, Jr., entitled “Hacker's Delight,” Addison-Wesley, 2003. It will also be appreciated by one of ordinary skill in the art that, while the Java programming language nominally provides only signed integer types and signed integer values, such types and values may be used to hold bit patterns that may also be regarded as representing unsigned integer values; for example, a 64-bit “long” bit pattern that ordinarily would be regarded as representing a signed 64-bit integer having mathematical value “v” that lies in the range [−2⁶³, 2⁶³−1] may also be regarded as representing an unsigned 64-bit integer having mathematical value “w” that lies in the range [0, 2⁶⁴−1], where “w” is equal to “v” if “v” is non-negative, but is equal to “v+2⁶⁴” if “v” is negative.

Lines 807 through 813 show a method “updateModGeorge” that accepts two arguments “x” and “y,” each a 64-bit “long” value, and returns a 64-bit “long” result. Line 808 adds the first argument “x” to the second argument “y” and gives the 64-bit result the name “p.” Line 809 tests to see whether the 64-bit value “p,” regarded as an unsigned 64-bit integer, is greater than or equal to the argument “y,” also regarded as an unsigned 64-bit integer; if it is, then the value “p” is returned as the value of the method “updateModGeorge.” It will be appreciated that “p” will be greater than or equal to “y,” both being considered as unsigned 64-bit integers, if and only if the addition in line 808, regarded as an addition of two unsigned 64-bit values, did not overflow. If, however, “p” compares smaller than “y” in line 809, indicating that overflow occurred in line 808, then execution continues to line 810. Line 810 subtracts the value 13 from the value “p” and gives the result the name “q.” Line 811 tests to see whether the 64-bit value “p,” regarded as an unsigned 64-bit integer, is greater than or equal to the constant 13, also regarded as an unsigned 64-bit integer; if it is, then the value “q” is returned as the value of the method “updateModGeorge.” It will be appreciated that “p” will be greater than or equal to 13, both being considered as unsigned 64-bit integers, if and only if the subtraction in line 810, regarded as a subtraction of two unsigned 64-bit values, did not underflow. If, however, “p” compares smaller than “y” in line 811, indicating that underflow occurred in line 810, then execution continues to line 812. Line 812 adds the value “q” to the second argument “y” and returns the result as the value of the method “updateModGeorge.”

It will be appreciated that if the second argument “y” of the method “updateModGeorge,” regarded as a 64-bit unsigned integer, lies in the range [13, 2⁶⁴−1], then the value returned by the method “updateModGeorge,” regarded as a 64-bit unsigned integer, is equal to either (x+y) mod (2⁶⁴+13) or (x+2y) mod (2⁶⁴+13). It will furthermore be appreciated that the value returned by the method “updateModGeorge,” regarded as a 64-bit unsigned integer, is equal to (x+2y) mod (2⁶⁴+13) if and only if (x+y) mod (2⁶⁴+13) is greater than or equal to 2⁶⁴.

Lines 815 through 819 show a method “nextDotProduct” that accepts no arguments, and returns a 64-bit “long” result. Line 816 calls the method “updateModGeorge” with two arguments, the “dotp” field and the “gamma” field of the instance of the “IncrementalRandom” class for which the method was invoked, and gives the result the name “result.” Line 817 stores the “result” value back into the “dotp” field of the instance of the “IncrementalRandom” class for which the method was invoked. Line 818 returns the same “result” value as the value of the method “nextDotProduct.” It will be appreciated that the “nextDotProduct” method has the side effect of updating the “dotp” field of the instance of the “IncrementalRandom” class for which the method was invoked, and therefore successive invocations of “nextDotProduct” may return different values.

Lines 821 through 828 show a method “mix64” that accepts one argument “z,” a 64-bit “long” value, and returns a 64-bit “long” result. This method implements the MurmurHash3 64-bit finalizer function described in the Appleby paper. Line 822 replaces “z” with the result of computing the bitwise exclusive OR of “z” and the result of performing an unsigned (zero-padding) right-shift of “z” by 33 bit positions. Line 823 replaces “z” with the low-order 64 bits of the result of multiplying “z” by the constant 0xff51afd7ed558ccdL. Line 824 replaces “z” with the result of computing the bitwise exclusive OR of “z” and the result of performing an unsigned (zero-padding) right-shift of “z” by 33 bit positions. Line 825 replaces “z” with the low-order 64 bits of the result of multiplying “z” by the constant 0xc4ceb9fe1a85ec53L. Line 826 replaces “z” with the result of computing the bitwise exclusive OR of “z” and the result of performing an unsigned (zero-padding) right-shift of “z” by 33 bit positions. Line 827 returns “z” as the value of the method “mix64.” It will be appreciated that the method “mix64” shown as Java code on lines 821 through 828 performs the same computation as the function “mix” shown as pseudocode on lines 622 through 628 of FIG. 6.

Lines 830 through 834 show a method “mix32” that accepts one argument “z,” a 64-bit “long” value, and returns a 32-bit “int” result. Line 831 replaces “z” with the result of computing the bitwise exclusive OR of “z” and the result of performing an unsigned (zero-padding) right-shift of “z” by 33 bit positions. Line 832 replaces “z” with the low-order 64 bits of the result of multiplying “z” by the constant 0xc4ceb9fe1a85ec53L. Line 833 performs an unsigned (zero-padding) right-shift of “z” by 32 bit positions, uses the 32 low-order bits of the result to produce an “int” value, and then returns that “int” value as the value of the method “mix32.” It will be appreciated that the method “mix32” advantageously uses only two of the five computational steps used in method “mix64” in order to produce just 32 pseudorandom bits from a 64-bit argument.

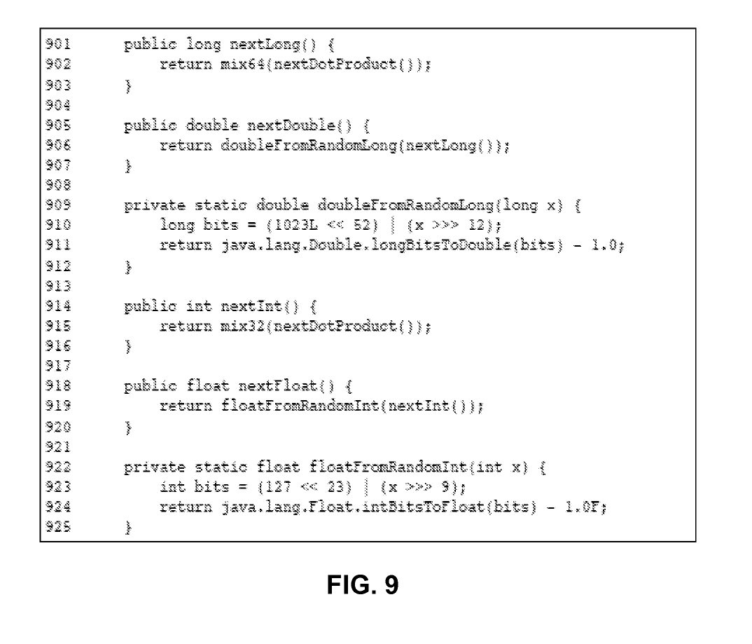

FIG. 9 shows four methods that can be used to generate one pseudorandom “long” or “double” result of “int” or “float” value. In each case, all that is needed is to call the “nextDotProduct” method, apply an appropriate mixing function “mix64” or “mix32,” and convert the result to the appropriate type.

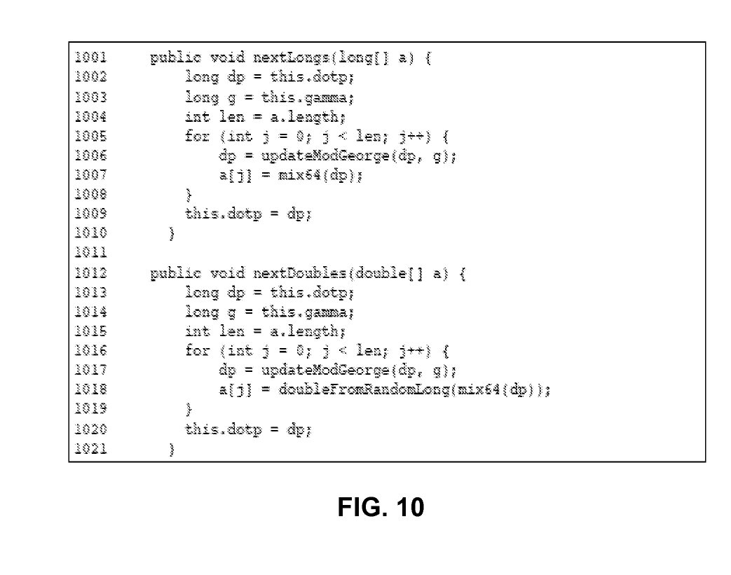

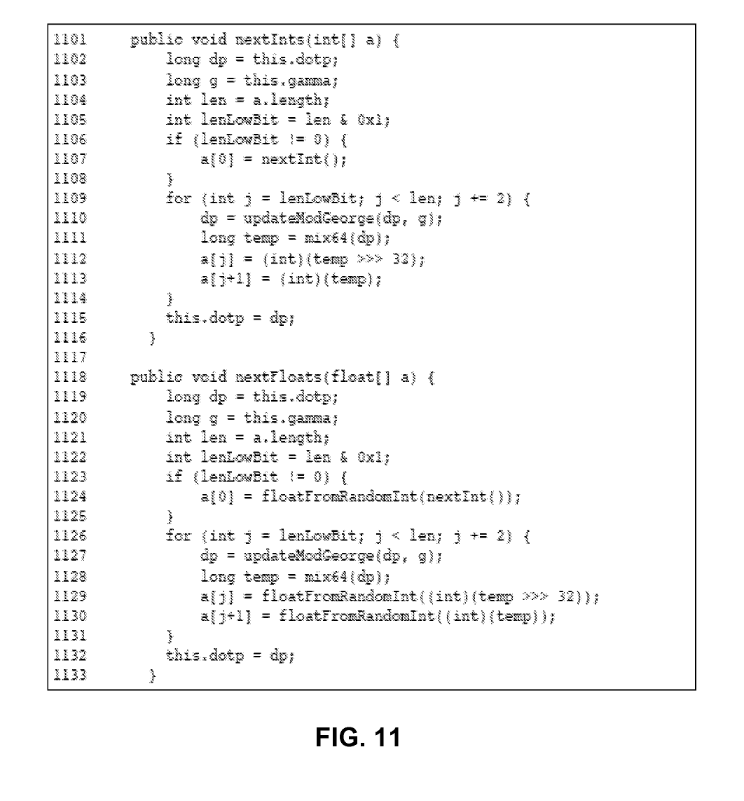

FIGS. 10-11 show four methods that can be used to fill a given array with pseudorandom values. Conceptually, each such method simply generates individual pseudorandom values of the appropriate type repeatedly and stores them into successive array elements. In actual implementation, efficiencies are gained through two techniques: (a) “lifting” fields “dotp” and “gamma” into local variables, then storing the final dot-product value back into the “dotp” field just once, which advantageously avoids traffic from and to main memory, and (b) in FIG. 11, when generating 32-bit values, instead of performing one call to method “nextDotProduct” for each generated value, perform one call to method “dotProduct” for every pair of generated values, which advantageously halves the number of calls needed to “nextDotProduct” and furthermore uses one call to “mix64” rather than two calls to “mix32.”

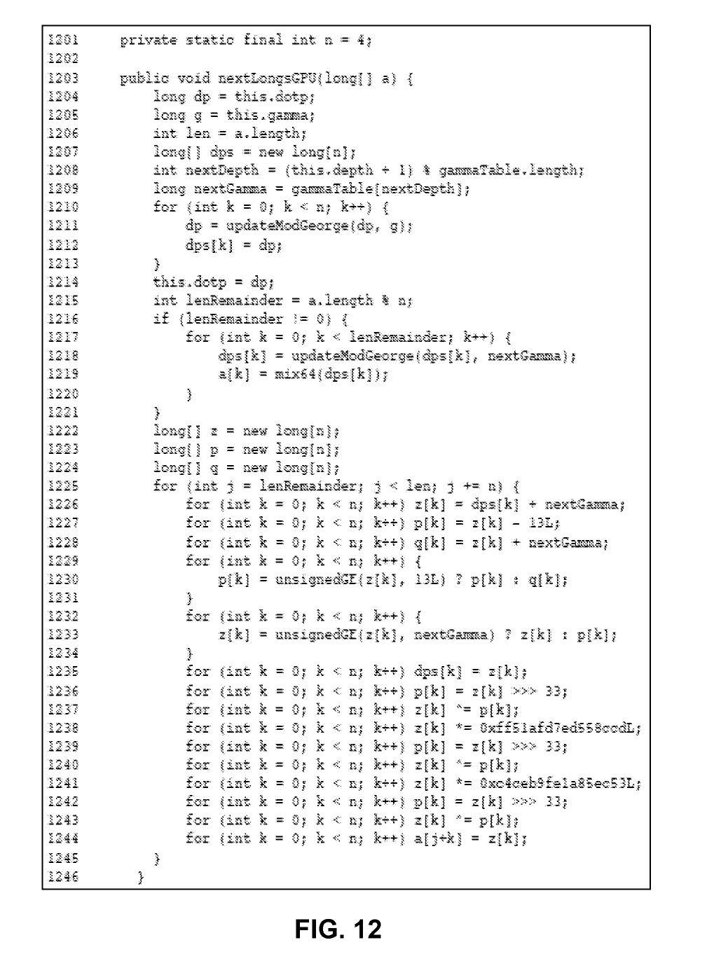

FIG. 12 shows another method for filling a given array with pseudorandom “long” values. In effect, it behaves as if calling the method “split” some number of times “n” to create “n” independent random number generators; then, it uses all “n” generators at each iteration to generate “n” new random values in parallel. The given array is then carved into blocks of length “n;” the blocks are filled one after another, sequentially, but the “n” values for each block are calculated in parallel. Furthermore, the steps of the calculation are each performed by a loop having “n” iterations. It will be appreciated that, on a suitable architecture such as Intel MMX, each of the loops on lines 1226 through 1244 could be implemented by a single SIMD vector instruction that performs “n” copies of a scalar operation.

Referring to FIG. 8, in an alternative embodiment, the two occurrences of the constant “13” appearing on lines 810 and 811 are replaced by some other constant “k,” such that k is less than 2⁶³, 2⁶⁴+k is a prime number, and every entry in “gammaTable” is required to be no smaller than k. It will be appreciated that this alternative embodiment effectively uses arithmetic modulo (2⁶⁴+k) rather than arithmetic modulo (2⁶⁴+13).

In an alternative embodiment, the fields “dotp” and “gamma” and the elements of the array “gammaTable” are represented as 128-bit integers rather than 64-bit integers, the two occurrences of the constant “13” appearing on lines 810 and 811 are replaced by the constant “51,” and every entry in “gammaTable” is required to be no smaller than 51. It will be appreciated that this alternative embodiment effectively uses arithmetic modulo the prime number (2¹²⁸+51) rather than arithmetic modulo (2⁶⁴+13).

It will furthermore be appreciated that many other choices of integer representation and prime number may be used without departing from the spirit and scope of the disclosed embodiments.

### Process of Generating a Pseudorandom Number

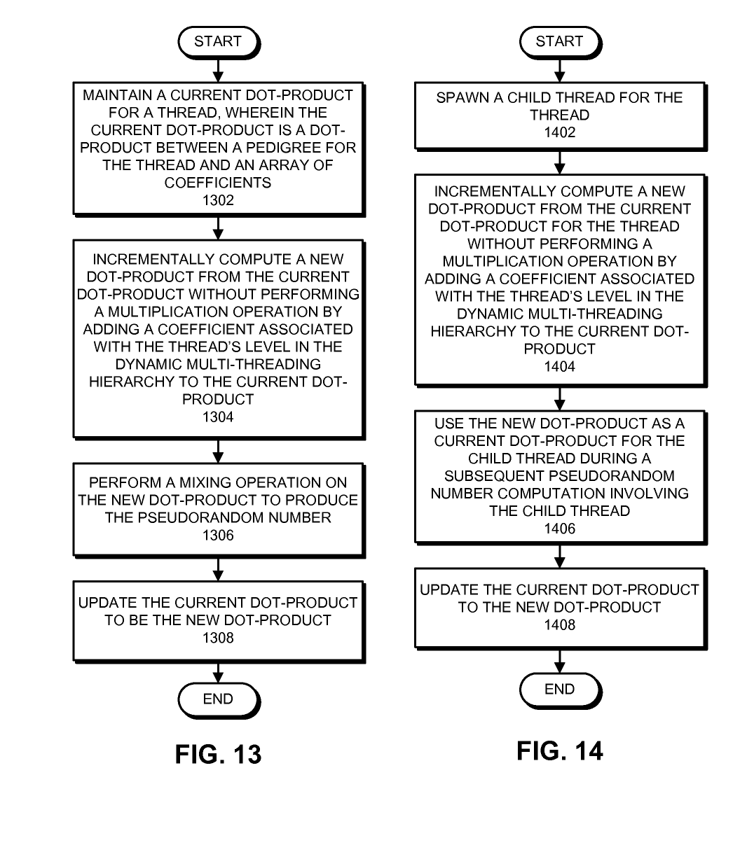

FIG. 13 presents a flow chart illustrating the process of generating a pseudorandom number in accordance with the disclosed embodiments. During operation, the system maintains a current dot-product for a currently executing thread (step 1302). The current dot-product is a dot-product between a pedigree for the thread and an array of coefficients, wherein the pedigree for the thread comprises an array of elements that specify a path to the thread from a root in a dynamic multi-threading hierarchy, and wherein the array of coefficients includes a coefficient for each level in the dynamic multi-threaded hierarchy.

To generate the pseudorandom number, the system incrementally computes a new dot-product from the current dot-product without performing a multiplication operation. This is accomplished by adding a coefficient associated with the thread's level in the dynamic multi-threading hierarchy to the current dot-product (step 1304). Next, the system performs a mixing operation on the new dot-product to produce the pseudorandom number (step 1306). Finally, the system updates the current dot-product to the new dot-product (step 1308).

FIG. 14 presents a flow chart illustrating the process of enabling a child process to generate pseudorandom numbers in accordance with the disclosed embodiments. At the start of this process, the system spawns a child thread for the thread (step 1402). Next, the system enables the child to generate pseudorandom numbers. To accomplish this, the system incrementally computes a new dot-product from the current dot-product for the thread by adding a coefficient associated with the thread's level in the dynamic multi-threading hierarchy to the current dot-product (step 1404). Then, the system uses the new dot-product as a current dot-product for the child thread during a subsequent pseudorandom number computation involving the child thread (step 1406). This system also updates the current dot-product to the new dot-product (step 1408).

### Computer System

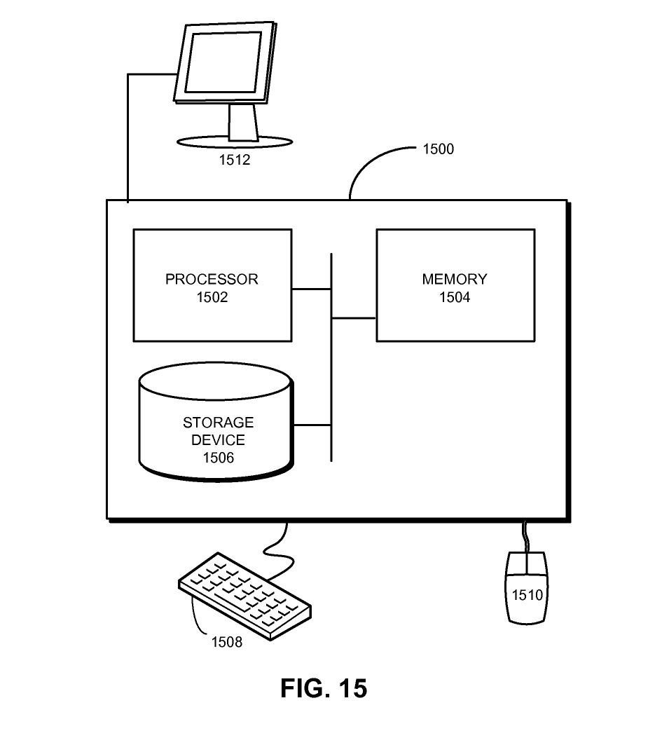

FIG. 15 illustrates a computer system 1500 in accordance with the disclosed embodiments. Computer system 1500 may correspond to an apparatus that includes a processor 1502, a memory 1504, a storage device 1506, and/or other components found in electronic computing devices such as personal computers, laptop computers, workstations, servers, mobile phones, tablet computers, and/or portable media players. Processor 1502 may include one or more processors and may support parallel processing and/or multi-threaded operation. Computer system 1500 may also include input/output (I/O) devices such as a keyboard 1508, a mouse 1510, and a display 1512.

Computer system 1500 may include functionality to execute various components of the present embodiments. In particular, computer system 1500 may include an operating system (not shown) that coordinates the use of hardware and software resources on computer system 1500, as well as one or more applications that perform specialized tasks for the user. To perform tasks for the user, applications may obtain the use of hardware resources on computer system 1500 from the operating system, as well as interact with the user through a hardware and/or software framework provided by the operating system.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for generating a pseudorandom number, comprising:
maintaining a current dot-product for a thread, wherein the current dot-product is a dot-product between a pedigree for the thread and an array of coefficients, wherein the pedigree for the thread comprises an array of elements that specify a path to the thread from a root in a dynamic multi-threading hierarchy, and wherein the array of coefficients includes a coefficient for each level in the dynamic multi-threaded hierarchy;
incrementally computing a new dot-product from the current dot-product without performing a multiplication operation by adding a coefficient associated with the thread's level in the dynamic multi-threading hierarchy to the current dot-product;
performing a mixing operation on the new dot-product to produce the pseudorandom number; and
updating the current dot-product to the new dot-product.

2. The computer-implemented method of claim 1, further comprising:
spawning a child thread for the thread;
incrementally computing a new dot-product from the current dot-product for the thread by adding a coefficient associated with the thread's level in the dynamic multi-threading hierarchy to the current dot-product;
using the new dot-product as a current dot-product for the child thread during a subsequent pseudorandom number computation involving the child thread; and
updating the current dot-product to the new dot-product.

3. The computer-implemented method of claim 1, wherein using the new dot-product as the current dot-product for the child thread involves communicating the new dot-product to the child thread outside of thread state information and outside of a system stack.

4. The computer-implemented method of claim 1, wherein performing the mixing operation includes using a MurmurHash3 64-bit finalizer function to perform the mixing operation.

5. The computer-implemented method of claim 1, wherein performing the mixing operation includes using a mix32 function to perform the mixing operation, wherein the mix32 function performs a subset of the operations in a MurmurHash3 64-bit finalizer function and produces a 32-bit result.

6. The computer-implemented method of claim 1, wherein adding the coefficient to compute the new dot-product includes performing an addition operation modulo a prime number that is larger than can be represented in an integer type being used for the addition operation.

7. The computer-implemented method of claim 6, wherein if performing the additional operation modulo the prime number produces a resulting value that is larger than can be represented in the integer type, the method further comprises performing a second addition operation modulo the prime number between the resulting value and the coefficient.

8. The computer-implemented method of claim 7, wherein the coefficients in the array of coefficients are selected to ensure that the second addition operation modulo the prime number results in a value that can be represented in the integer type.

9. A non-tangible computer-readable storage medium storing instructions that when executed by a computer cause the computer to perform a method for generating a pseudorandom number, the method comprising:
maintaining a current dot-product for a thread, wherein the current dot-product is a dot-product between a pedigree for the thread and an array of coefficients, wherein the pedigree for the thread comprises an array of elements that specify a path to the thread from a root in a dynamic multi-threading hierarchy, and wherein the array of coefficients includes a coefficient for each level in the dynamic multi-threaded hierarchy;
incrementally computing a new dot-product from the current dot-product without performing a multiplication operation by adding a coefficient associated with the thread's level in the dynamic multi-threading hierarchy to the current dot-product;
performing a mixing operation on the new dot-product to produce the pseudorandom number; and
updating the current dot-product to the new dot-product.

10. The non-tangible computer-readable storage medium of claim 9, wherein the method further comprises:
spawning a child thread for the thread;
incrementally computing a new dot-product from the current dot-product for the thread by adding a coefficient associated with the thread's level in the dynamic multi-threading hierarchy to the current dot-product;
using the new dot-product as a current dot-product for the child thread during a subsequent pseudorandom number computation involving the child thread; and
updating the current dot-product to the new dot-product.

11. The non-tangible computer-readable storage medium of claim 9, wherein using the new dot-product as the current dot-product for the child thread involves communicating the new dot-product to the child thread outside of thread state information and outside of a system stack.

12. The computer-implemented method of claim 9, wherein performing the mixing operation includes using a MurmurHash3 64-bit finalizer function to perform the mixing operation.

13. The non-tangible computer-readable storage medium of claim 9, wherein performing the mixing operation includes using a mix32 function to perform the mixing operation, wherein the mix32 function performs a subset of the operations in a MurmurHash3 64-bit finalizer function and produces a 32-bit result.

14. The non-tangible computer-readable storage medium of claim 9, wherein adding the coefficient to compute the new dot-product includes performing an addition operation modulo a prime number that is larger than can be represented in an integer type being used for the addition operation.

15. The non-tangible computer-readable storage medium of claim 14, wherein if performing the additional operation modulo the prime number produces a resulting value that is larger than can be represented in the integer type, the method further comprises performing a second addition operation modulo the prime number between the resulting value and the coefficient.

16. The non-tangible computer-readable storage medium of claim 14, wherein the coefficients in the array of coefficients are selected to ensure that the second addition operation modulo the prime number results in a value that can be represented in the integer type.

17. A system that generates a pseudorandom number, comprising:
a processor;
a memory;
an operating system that supports dynamic multi-threading; and
a random number generation mechanism configured to,
maintain a current dot-product for a thread, wherein the current dot-product is a dot-product between a pedigree for the thread and an array of coefficients, wherein the pedigree for the thread comprises an array of elements that specify a path to the thread from a root in a dynamic multi-threading hierarchy, and wherein the array of coefficients includes a coefficient for each level in the dynamic multi-threaded hierarchy,
incrementally compute a new dot-product from the current dot-product without performing a multiplication operation by adding a coefficient associated with the thread's level in the dynamic multi-threading hierarchy to the current dot-product,
perform a mixing operation on the new dot-product to produce the pseudorandom number, and
update the current dot-product to the new dot-product.

18. The system of claim 17, wherein the random number generation mechanism is further configured to:
spawn a child thread for the thread;
incrementally compute a new dot-product from the current dot-product for the thread by adding a coefficient associated with the thread's level in the dynamic multi-threading hierarchy to the current dot-product;
use the new dot-product as a current dot-product for the child thread during a subsequent pseudorandom number computation involving the child thread; and
update the current dot-product to the new dot-product.

19. The system of claim 17, wherein the random number generation mechanism is configured to use a MurmurHash3 64-bit finalizer function to perform the mixing operation.

20. The system of claim 17, wherein while adding the coefficient to compute the new dot-product, the random number generation mechanism is configured to perform an addition operation modulo a prime number that is larger than can be represented in an integer type being used for the addition operation.
